(19) United States
(12) Patent Application Publication
(10) Pub. No.: US 2018/0158269 A1
(43) Pub. Date: Jun. 7, 2018

(54) SYSTEM AND METHOD FOR IDENTIFYING FRAUD ATTEMPT OF AN ENTRANCE CONTROL SYSTEM

(71) Applicant: FST21 Ltd., Holon (IL)

(72) Inventors: Ofir FRIEDMAN, Nes Ziona (IL); Shahar Belkin, Kibbutz Brur Chayil (IL); Ido Shlomo, Tel-aviv (IL)

(21) Appl. No.: 15/129,005

(22) PCT Filed: Mar. 25, 2015
(86) PCT No.: PCT/IL2015/050315

§ 371 Date: Sep. 26, 2016

(30) Foreign Application Priority Data
Mar. 27, 2014 (IL) 231789

(51) Int. Cl. G07C 9/00; G06K 9/00; G06T 7/13

(52) U.S. Cl. CPC G07C 9/00563; G06T 7/13; G06K 9/00288; G06K 9/00228

(57) ABSTRACT

Embodiments of the present invention provide a system and a method for identifying a fraud attempt of an entrance control system. Some embodiments, may comprise obtaining by an imaging system a plurality of images of an entrance point to secured area, extracting image information from at least one of the plurality of images, to identify a person in the entrance point vicinity, retrieve from a memory of the entrance control system stored data associated with the identified person, apply a plurality of deception detection tools on the image information, assign a unique fraud grade by each deception detection tool, calculating a combined fraud grade, and comparing the combined fraud grade to a threshold value to determine likelihood of fraud.

### BACKGROUND OF THE INVENTION

Entry control systems using biometric identification such as face recognition and voice recognition are well known and are in use in secured facilities throughout the world. Such systems usually comprise a camera or a dedicated scanner to scan a face of a person or a part thereof to obtain an image thereof and/or a microphone to obtain a voice sample. Such entry control systems further comprise a processor to analyze the obtained image or voice sample and extract biometric) information from the obtained input. Typically, the system further comprises a database to store pre-obtained biometric information of a plurality of people and their access or entrance authorization. The processor compares biometric information extracted from the obtained image with information stored in the database. When a sufficient match is found between the stored data and the data extracted from the obtained face image or voice sample, the identity of the person is authenticated and if the identified person's authorization allows it, entrance to a secured area may be allowed.

However, entrance control systems may be deceived by presenting a pre-obtained image or images of a person's face or a video of the person's face, to a camera, a scanner or any other input device of the entrance control system. Similarly, voice recognition systems may be deceived by presenting pre-obtained recording of a person's voice sample.)

One object of the present invention is to provide an entrance control system that obviates the disadvantages of known entrance control systems and in particular prevents fraud of an entrance control system.

### SUMMARY OF THE INVENTION

Embodiments of the present invention provide a method for identifying a fraud attempt of an entrance control system. The method, according to some embodiments, may comprise obtaining by an imaging system a plurality of images of an entrance point to secured area; extracting image information from at least one of the plurality of images, to identify a person in the entrance point vicinity; retrieve from a memory of said entrance control system stored data associated with said identified person; apply a plurality of deception detection tools on said image information and) assign a unique fraud grade by each deception detection tool.

According to some embodiments, the method may further comprise calculating a combined fraud grade; and comparing said combined fraud grade to a threshold value to determine likelihood of fraud.

The method according, to some embodiments may further comprise allowing entrance to the secured area when the combined fraud grade is below the threshold value.

According to some embodiments, the plurality of deception detection tools may be two or more from a group consisting of: edge recognition tool, background coverage tool, brightness identification tool, blur determination tool, arm location identification tool, 3D gaze determination tool, red eye determination tool, normal behavior determination tool, and tools for extracting vocal biometric information

According to some embodiments, each of the plurality of deception detection tools may assign a grade indicative of the probability of deception.

According to yet additional embodiments, the method may comprise assigning a weight to each grade and calculating the combined grade based on the weighted grades given by each deception detection tool.

According to some embodiments the weight for each grade is determined according to the accuracy and reliability of each of the plurality of deception detection tools. According to some embodiments the weight is determined according to the conditions in the location of an image input device, such as lighting conditions.

According to some embodiments of the present invention, the method may further comprise applying at least one additional deception detection tool when the combined grade is above the threshold value.

Embodiments of the present invention further provide a system for detecting deception attempts of an entrance control system, the deception detection system may comprise an image input device; a processor associated with the image input device; and a memory, the memory may be adapted to store a plurality of image analysis tools, biometric information and authorization information of at least one person.

According to some embodiments the processor is adapted to receive at least two images from the image input device and apply at least two of the plurality of image analysis tools to determine deception attempt.

The system according to some embodiments may further comprise an audio input device. According to some embodiments, the memory further stores analysis tools to obtain vocal biometric information from input received from said audio input device.

The system according to some embodiments may further comprise an illumination source, such as an Infrared illuminator.

According to some embodiments, the processor is in active communication with a lock, the lock may be adapted to change its position from locked position to unlocked position upon receipt of a signal from the processor.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is schematic illustration of a system for detecting deception attempts on a face recognition entrance control system according to one embodiment of the present invention;

FIG. 2 is a flowchart of a method for identifying deception attempts of an entrance control system according to one embodiment of the present invention;

FIG. 3 is a flowchart of a method for identifying and grading framing of an image according to one embodiment of the present invention, for identifying deception attempts of an entrance control system according to the method of FIG. 2;

FIG. 4 is a flowchart of a method for identifying and grading background coverage according to one embodiment of the present invention, for identifying deception attempts of an entrance control system according to the method of FIG. 2;

FIG. 5 is a flowchart of a method for identifying and grading facial movements according to one embodiment of the present invention, for identifying deception attempts of an entrance control system according to the method of FIG. 2;

FIG. 6 is a flowchart of a method for identifying and grading image blur according to one embodiment of the present invention, for identifying deception attempts of an entrance control system according to the method of FIG. 2; and

FIG. 7 is a flowchart of a method for identifying and grading image brightness according to one embodiment of the present invention, for identifying deception attempts of an entrance control system according to the method of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Unless explicitly stated, the method embodiments described herein are not constrained to a particular order or sequence. Additionally, some of the described method embodiments or elements thereof can occur or be performed at the same point in time or overlapping points in time. As known in the art, an execution of an executable code segment such as a function, task, sub-task or program may be referred to as execution of the function, program or other component.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

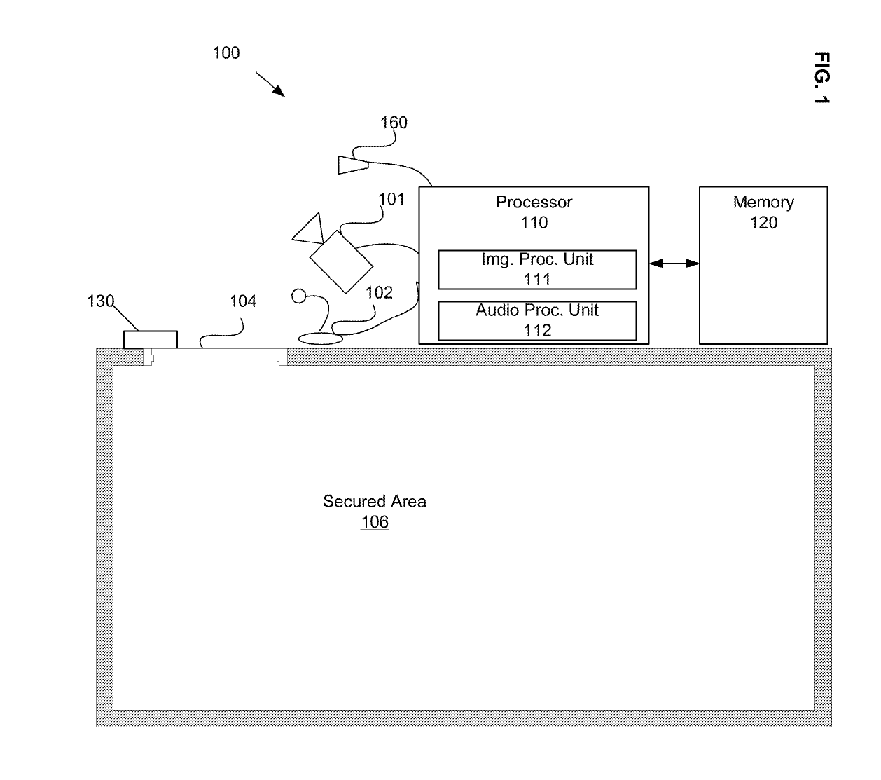

As may be seen in FIG. 1 an entry control system 100 may comprise a visual input device 101 and a vocal input device 102. Visual input device 101 may be a camera, a scanner or any other type of device known in the art that may provide an image of a face of a person, or a part thereof. Vocal input device 102 may be a microphone or any other input device that may obtain a voice sample from a person as may be known in the art. According to one embodiment of the present invention, vocal input device 102 may not be required.

Input devices 101 and 102 may be located proximate to an entrance point 104 to a secured area 106, to obtain images and voice samples of persons attempting to enter secured area 106.

Visual input device 101 and vocal input device 102 may be in active communication with a processor 110 and may provide images, video streams and/or voice records, respectively, preferably in digital formats, of the person requesting entry approval. Processor 110 may have an image processing unit 111 and an audio processing unit 112.

Processor 110 may also be in active communication with memory unit 120. Memory unit 120 may be an external device, installed and/or realized outside of processor 110. According to some embodiments of the present invention, memory 120 may be an integral part of processor 110. Memory 120 may store biometric information and authorization information of at least one person, as well as programs required for the operation of system 100.

According to some embodiments system 100 may further comprise illumination source 160. Illumination source 160 may be according to some embodiments, a white light illuminator. According to other embodiments, illumination source 160 may be an Infrared (IR) illuminator. Other or additional illumination sources may be used, as known in the art.

Image processing unit 111 may apply different image analysis tools in order to extract biometric information such as distance between the eyes, distance between the nose, eyes and cheek bones, face orientation and additional visible features from the human face.

Image processing unit 111 may further comprise image analysis tools used to determine deception attempt of system 100. One type of deception may be the appending of an image of a face expected to have entrance approval onto a non-natural background image (i.e.—‘importation’ of the face image onto a ‘foreign’ background, in order to fake an allowable picture).

According to some embodiments of the present invention, tools for the detection of such deception may be, for example, edge recognition tools capable of identifying the edge of an imported face image. According to some embodiments of the present invention, edge recognition tools search for straight lines in an image, having a length greater than a predetermined number of pixels. High fraud grade is determined by the edge recognition tool, when a straight line longer than a predefined number of pixels is identified around the face area. According to some embodiments, edge detecting tools may search for at least two straight lines around a detected face in an image, which are parallel to each other or intersecting each other. The fraud grade may be increased if a frame recognition tools detect a frame around the face, for example, when two straight lines have been identified in the area around the face and they are perpendicular or parallel to each other.

According to some embodiments, background coverage tools may also be used in order to identify fraud. According to some embodiments, when an area of the background is ‘covered’ by anything other than the human head/face or if the contrast changes at the edge line between the general background and the background immediately around the face's edge line this may indicate of a fraud attempt and a high fraud grade may be given by the background coverage tool.

According to some embodiments, in addition or instead of one or more of the above tools, a brightness identification tool may be applied to determine potential fraud. For example, when the brightness of a face in an image is inconsistent with the ambient brightness as measured in the background area around the face, a potential fraud attempt may be indicated and the fraud grade in the brightness test may indicate the potential fraud identified by the brightness identification tool. Inconsistency of brightness in a captured image may be determined.

According to some embodiments, a blur determination tool may be used in addition to or instead of one or more of the aforementioned deception detection tools.

Blur determination tool, according to embodiments of the present invention, may scan an image and may determine, based on image processing, whether the picture of for example a face in the captured video stream is blurred (i.e. out of focus) for more than a predefined period of time. It should be appreciated by those skilled in the art that when the face image in a captured video stream is blurry for over a threshold time period, such as over 3 seconds, that may indicate a fraud attempt and the fraud grade assigned by the blur detection tool may indicate a fraud attempt.

According to some embodiments, arm location identification tool may be used in addition to or instead of one or more of the aforementioned deception detection tools, to identify fraud attempts based on the location of the arms with respect to the identified face in the captured image. For example, the higher the arms or shoulders are (i.e. closer to the person's head) during the person' s approach to the access point to the secured area, the higher the fraud grade assigned by the arm location identification tool is.

According to some embodiments, a 3D gaze determination tool may be used in addition to or instead of one or more of the aforementioned deception detection tools, to identify fraud attempts based on the deviation in a face direction in consecutive images obtained by visual input device 101. For example, according to some embodiments, if the direction of gaze of a face detected in consecutive images have abnormal deviation (e.g. that does not comply with the expected natural movement of a 3D face as deduced from pre-obtained video streams of the person's gazing), this may indicate a fraud attempt and a fraud grade indicative of an intended fraud may be assigned by 3D gaze determination tool.

According to some embodiments of the present invention, a red eye determination tool may be used in addition to or instead of one or more of the aforementioned deception detection tools. Red eye determination tool may illuminate the eyes of a person with IR illuminator 160 and measure the reflection of IR light from the eyes of the person at the entrance point to the secured area. Red eye determination tool may assign a higher fraud grade as the reflection from the eyes of the person deviates from the person's normal reflection stored in the system's memory 120.

According to some embodiments, normal behavior determination tool may be used in addition to or instead of one or more of the aforementioned deception detection tools. Normal behavior determination tool may obtain consecutive images of a person approaching an entrance point and by comparing the images by processing unit 111, a current route, speed and height of the person may be extracted and a current behavioral vector may be calculated. According to some embodiments, the current behavioral vector may be compared to a pre-stored behavioral vector collected and stored by the system for every person having authorization to enter the secured area. According to some embodiments the bigger the deviation is between current behavioral vector and the pre-stored behavioral vector the bigger will be the fraud grade assigned by the normal behavior determination tool.

According to some embodiments of the present invention, audio processing unit 112 may comprise tools for extracting vocal biometric information from a voice sample, such as pitch, intonation, rhythm, amplitude and the like.

The analysis tools of audio processing unit 112 may provide a grade which may be indicative of the correlation between the pre-stored vocal biometric information of a person having authorization to enter the secured area and the vocal biometric information extracted from the obtained voice sample when a person is attempting to enter that area. This grade may be later compared to a pre-defined threshold in order to provide a decision of whether the person whose voice was analyzed may be permitted. To prevent the use of a pre recorded voice the system may request the person to say a specific randomly selected phrase, word, code, number and the like.

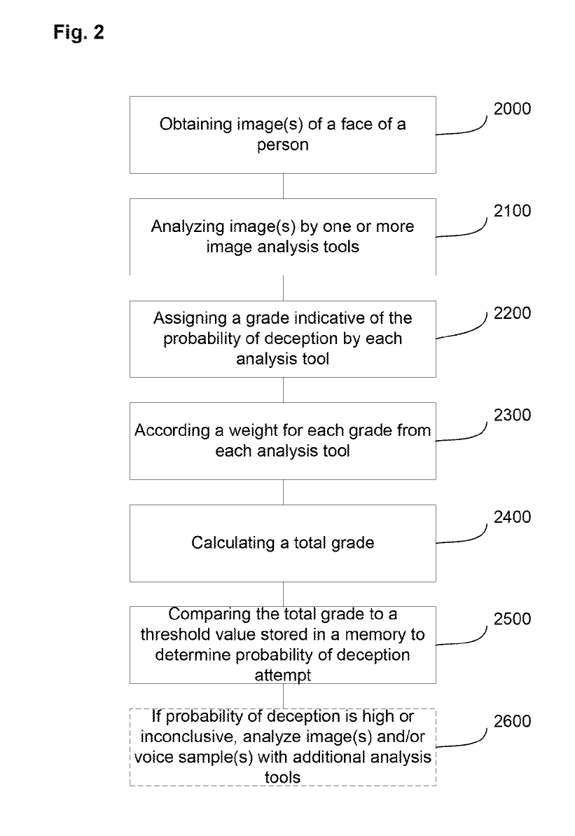

As will be further detailed with reference to FIGS. 2-7, when one of the above analysis tools is applied to an image received from visual input device 101, the analysis tool may provide a grade which may be indicative of the probability of deception. Each grade may be in a predefined range. For example, a grade may be in the range of 1 to 10, when 1 indicates low probability of deception and 10 indicates high probability of deception. It would be appreciated by those skilled in the art that other ranges may be used.

According to some embodiments of the present invention, each grade from each analysis tool may receive a weight, for example according to the accuracy and reliability of each tool in determining probability of deception, and according to the specific conditions, such as the conditions in the location of visual input device 101. For example, in certain lighting conditions, edge recognition tools may be more accurate than in other lighting conditions. Thus, the grade calculated based on image received from the edge recognition tool may have different weights in different light conditions. It would be appreciated by those skilled in the art that other environmental conditions may affect the accuracy and reliability of each deception determination image analysis tool.

According to some embodiments of the present invention processor 110 may calculate a combined grade indicative of the probability of deception based on specific grades received from specific tools. The combined grade may be a result of adding and/or subtracting the different grades, each grade multiplied by its weight, as presented in Equation 1:

TG=αG₁±βG₂±γG₃± . . . ±nGₙ

α+β+γ+ . . . +n=1

wherein:
TG is the total grade;
Gᵢ is the grade given by analysis tool i; and
α, β, γ, . . . , n are the weights given to each grade.

It is noted that Equation 1 above is presented for exemplary purposes, and that additional or alternative equations, functions, formulas, parameters, algorithms, assumptions and/or calculations may be used in accordance with embodiments of the invention.

According to one embodiment of the present invention, when the total grade is, for example, above a predefined threshold, an indication of probable deception may be provided and additional identity verification checks may be required. According to some embodiments, the different analysis tools may be applied in a predefined sequence so that only if the probability of deception grade calculated by a first analysis tool is, for example, above a predefined grade, an additional analysis tool may be applied and another grade may be calculated. According to yet another embodiment of the present invention a group of analysis tools may be applied in a first stage, and only if the calculated total grade of the first group is, for example, above a predefined grade value a second group of analysis tools may be applied. For example, according to one embodiment of the present invention, a voice sample may be required only if the total grade received from the analysis of the information received from visual input device 101 indicates probability of deception higher than a predefined value.

Processor 110 may further be in active communication with lock 130. Lock 130 may be attached to a door or any other barrier disposed to prevent unauthorized entry to a secured area. According to some embodiments of the present invention, lock 130 may be controlled by processor 110. When biometric information extracted from an image and/or voice sample received from input devices 101 and 102 corresponds to biometric information stored in memory 120, and the weighted grade of probability of deception is below a predefined threshold, a positive identification and authentication is achieved. When the identified person is authorized to enter the secured area, processor 110 may send an indication to lock 130 and change lock's 130 position from locked to unlocked.

According to some embodiments of the present invention, when the position of lock 130 is changed an indication may be provided such as a sound indication or a light indication.

Reference is now made to FIG. 2 which is a flowchart of a method for identifying deception attempts of an entrance control system according to one embodiment of the present invention.

According to an embodiment of the present invention, a method for identifying deception attempts may include the following steps:

Obtaining at least one image of a face of a person, the identity of whom is to be authenticated by an entrance control system [block 2000]. According to some embodiments of the present invention the image or images may be obtained by an input device such as a camera, a video camera, by a scanner or by any other suitable device capable of obtaining an image or a video stream. The image may be of the entire face, or a part of the face. According to some embodiments of the present invention, the image may be a profile image or a frontal image. It would be appreciated by those skilled in the art that other imaging directions/orientations may be used.

The obtained image or images may be analyzed and processed by image analysis tools in image processing unit [block 2100]. Each analysis tool in image processing unit may assign a grade to the image. The grade may be indicative of the probability of deception attempt by the analyzed image [block 2200]. According to some embodiments of the present invention, each grade received from each analysis tool in image processing unit, may be accorded a weight [block 2300]. The weight for each grade from each analysis tool may be determined, for example, based on the accuracy of the analysis tool in determining deception and based on the conditions in which the image or images have been obtained.

After receiving the grade from each analysis tool a total grade may be calculated [block 2400]. According to one embodiment of the present invention, the total grade may be calculated by multiplying each grade assigned by each analysis tool by the weight associated with each grade, and then adding or subtracting all weighted grades assigned by all analysis tools, as shown, for example, in Equation 1 above.

According to one embodiment of the present invention, the total grade may be compared to a predetermined threshold value [block 2500]. When the total grade is in a first range relative to the predetermined threshold a high probability of deception may be indicated. When the total grade is in a second range relative to the predetermined threshold a low probability of deception may be indicated. For example, when the grades assigned by each analysis tool are in the range of 1 to 10, where 1 indicates low probability of deception and 10 indicates high probability of deception, and the calculated total grade is 7. If the predetermined threshold is 6.5 an indication of high probability of deception may be provided. If the predetermined threshold is 8, a low probability of deception may be indicated. According to some embodiments of the present invention, further indications may be provided, such as an indication for inconclusive results, an indication of certain deception and the like. It would be appreciated that other or additional grade scales may be used and alternative or additional indications may be provided.

According to one embodiment of the present invention, when the total grade indicates that there is high probability of deception, or that the results are inconclusive, additional analysis tools may be applied to the image or images obtained [block 2600]. According to yet another embodiment of the present invention, the additional analysis tools may be in addition or alternatively, vocal analysis tools to analyze a voice sample obtained by vocal input device such as a microphone. It would be appreciated by those skilled in the art that according to some embodiments of the present invention, voice analysis may be used as one of the analysis tools used to determine the total grade of probability of deception. According to other embodiments, voice analysis may be used only as an additional tool for verification when the total grade is inconclusive or when additional check is required.

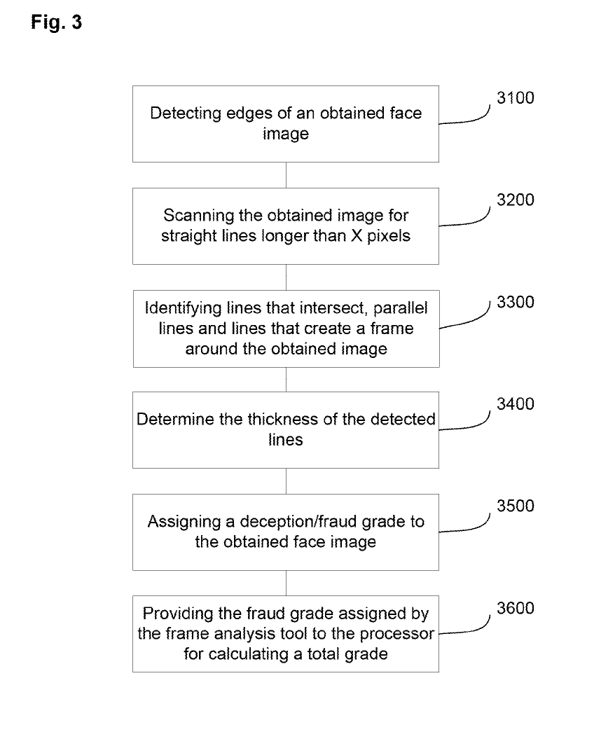

FIGS. 3 to 7 illustrate several analysis tools that may be used in determining deception attempts according to the method described above with reference to FIG. 2.

FIG. 3 is a flowchart of a method for identifying and grading framing of an image according to one embodiment of the present invention, for identifying deception attempts of an entrance control system according to the method of FIG. 2. As seen in FIG. 3, framing identification analysis tool processes an obtained image of a face to identify the edges of an image [block 3100]. After identifying the edges of the obtained face image, the analysis tool scans the image for straight lines [block 3200]. Then, the framing analysis tool may determine whether the identified straight lines that intersect, that are parallel and lines that create a frame around the face in the obtained image [block 3300] and determine the thickness of the straight lines creating the frame [block 3400].

Finally, the framing analysis tool may assign a grade to an obtained face image, based on the results of the framing analysis [block 3500]. According to some embodiments of the present invention, if the straight lines identified in the image create a frame around the face in the image a grade that indicates deception attempt may be assigned by the analysis tool. According to some embodiments of the present invention in determining the exact grade assigned by the framing analysis tool, the certainty of identification of a frame may be considered. Alternatively or additionally, the thickness of the identified frame lines may be considered in determining the grade assigned by the framing analysis tool. For example, framing analysis tool may assign an image a grade in the range from 1 to 10. If a frame is identified with high certainty and the frame has thick lines, a grade indicating high probability of deception may be assigned by framing analysis tool.

The grade assigned by frame analysis tool may be received by the processing unit for use in determining a total grade for an obtained image [block 3600].

It will be appreciated by those skilled in the art that the reliability of framing analysis as described above may be influenced by the conditions in which the face image is obtained. For Example, if the background in which the face image is obtained is dark, framing analysis may have limited accuracy and reliability. Thus, the weight given to the grade provided by the frame analysis tool may be reduced in such conditions.

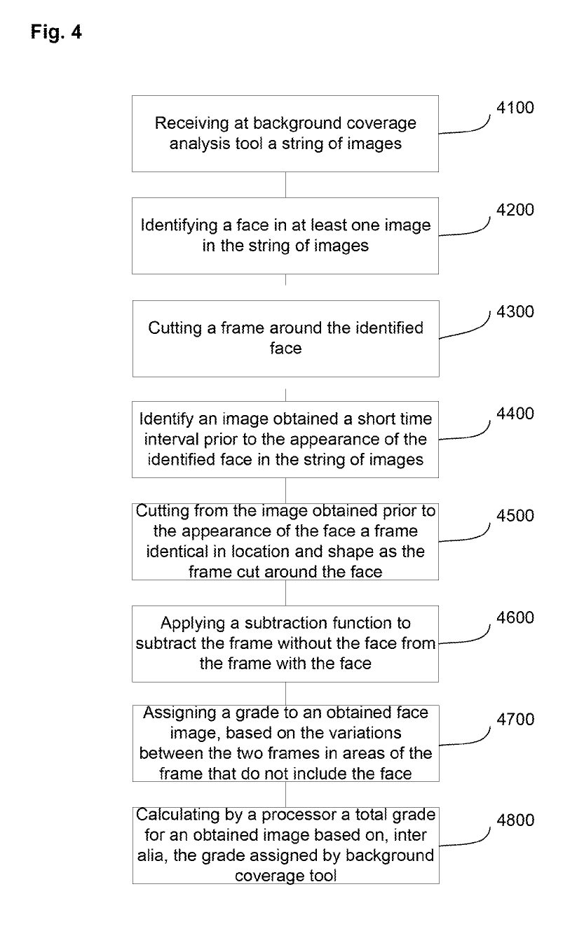

Reference is now made to FIG. 4 which is a flowchart of a method for identifying and grading background coverage according to one embodiment of the present invention. As seen in FIG. 4, background coverage analysis tool receives a string of images such as a video from image input device such as a video camera [block 4100]. Background coverage analysis tool may then identify a face in at least one image in the string of obtained images [block 4200], and cut a frame, such as a square frame, around the identified face in the at least one image in the string of images [block 4300]. The background cover analysis tool may further identify an image, obtained a short time interval prior to the appearance of a face in the string of images, in which the same area is shown [block 4400], and cut therefrom a frame of the same area captured in block 4300 above [block 4500]. Then, a subtraction function may be applied to subtract the frame without the face from the frame of the same area but including the face [block 4600]. The outcome of this step should be a subtracted image including only variations between the two subtracted frames. Thus, in authentic images captured by the image input device, the subtracted image should include the face of the identified person and minor variations in the remaining area of the image due to shadows and changes in light conditions. The background coverage analysis tool may assign a grade to an obtained face image, based on the variations between the two frames in areas of the frame that do not include the face [block 4700]. It would be appreciated that significant variations in the background areas of the images when subtracting the two frames may indicating that the coverage of background is of an area larger than the size of the face in the image, and thus may indicate deception attempt. When only minor variations are detected in the background areas around the face, it may indicate low probability of deception. It would be further appreciated that even when there is no deception attempt, minor variations may be identified due to changes in surrounding conditions such as changes in lighting, shadows, wind and the like.

According to some embodiments of the present invention, if the variations in the background around the face in the subtracted image are significant, a grade that indicates deception attempt may be assigned by the analysis tool. According to some embodiments of the present invention in determining the exact grade assigned by the background coverage analysis tool, the amount and significance of variations in the subtracted image may be considered. Other or additional considerations may affect the grade, such as the location of the variations in the background with respect to the location of the face in the image,

The grade assigned by background coverage analysis tool may be received by the processing unit for use in determining a total grade for an obtained image [block 4800].

It will be appreciated by those skilled in the art that the reliability of background coverage analysis as described above may be influenced by the conditions in which the face image is obtained. Thus, the weight given to the grade provided by the background coverage analysis tool may be adjusted according to the conditions at site including but not limited to the pattern on the walls, floor, carpet and plants.

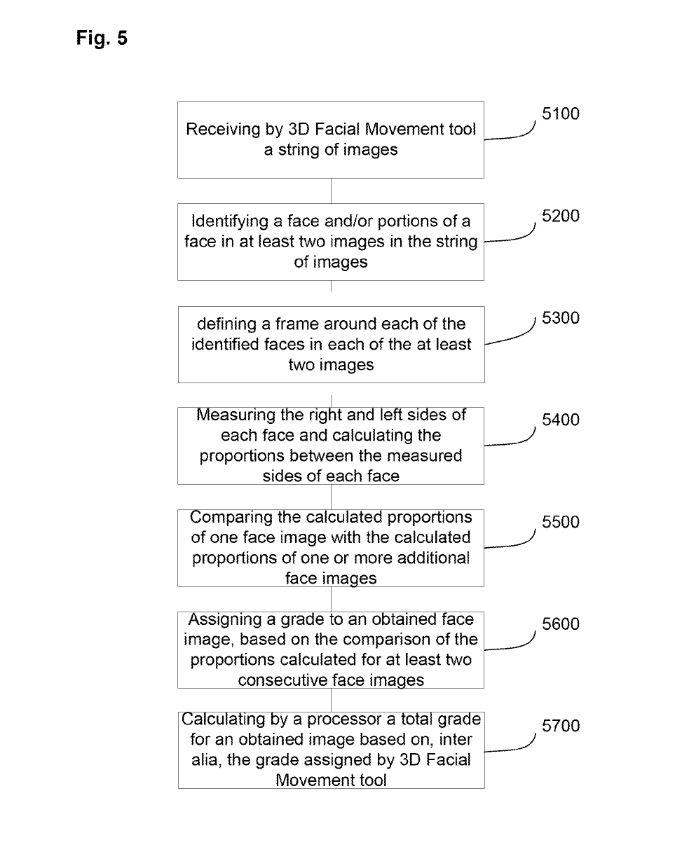

Reference is now made to FIG. 5 which is a flowchart of a method for identifying and grading 3D facial movement according to one embodiment of the present invention. As seen in FIG. 5, 3D facial movement analysis tool may receive a string of images such as a video stream from image input device such as a video camera [block 5100]. 3D Facial movement analysis tool may then identify a certain face in at least two images in the string of obtained images [block 5200], and define frames, such as a square frames, around the identified face in the at least two images in the string of images [block 5300]. The 3D facial movement analysis tool may further identify in each face image in the identified frames, specific portions, such as the chin, the forehead, the eyes and ears.

Calculating the proportions between measurements performed at the right side of the face to the same measurements at the left side of the face in two or more consecutive face images [block 5400]. This may be done by measuring the number of pixels between two identified portions of the face image to have the same number of pixels between the two identified positions of the face. For example, the number of pixels between the center of the right eye to the center of the nose (for example 54 pixels) and the number of pixels between the center of left eye to the center of the nose (for example 65 pixels). The proportion in this example is 65/54 the same proportions are calculated in additional images and then compared [block 5500]; the proportions in a 3D moving face are expected to change all the time. Larger change will generate smaller fraud grade.

It would be appreciated by those skilled in the art that most of the variations between the two consecutive images of a portion of a face may be due to facial movement. Thus, in authentic images of real face captured by the image input device, the product of difference between consecutive images should include variations in many portions of the face, and these variations may be different from one part of the face to another. Lack of such variations may be indicative of deception attempt. For example, if all parts of the face show exact same linear movement and/or exact same rotational movement, or show no movement at all this may be indicative of a deception attempt. The 3D facial movement analysis tool may assign a grade to each subtracted frame of a face portion or a single grade for all frames, based on the variations between the at least two frames of at least one portion of the face in at least two consecutive images [block 5600]. It would be appreciated that insignificant variations in the face portion frames of two consecutive images may indicate that no facial movement has been viewed, and thus may indicate deception attempt. When substantial variations are detected in the face portions, it may indicate low probability of deception. It would be further appreciated that even when there is no facial movement, minor variations may be identified due to changes in surrounding conditions.

According to some embodiments of the present invention in determining the exact grade assigned by the 3D facial movement analysis tool, the amount and significance of variations in the proportions in the image may be considered. Other or additional considerations may affect the grade, such as the specific portion of the face examined.

According to some embodiments of the present invention, each portion of the face may receive a separate grade and then an average may be calculated to determine a total grade. Other methods for determining a total grade by the 3D facial movement analysis tool may be used.

The grade assigned by facial movement analysis tool may be received by the processing unit for use in determining a total grade for an obtained image [block 5800].

It will be appreciated by those skilled in the art that the reliability of 3D facial movement analysis as described above may be influenced by the conditions in which the face image is obtained. Thus, the weight given to the grade provided by the facial movement analysis tool may be adjusted according to the conditions at site.

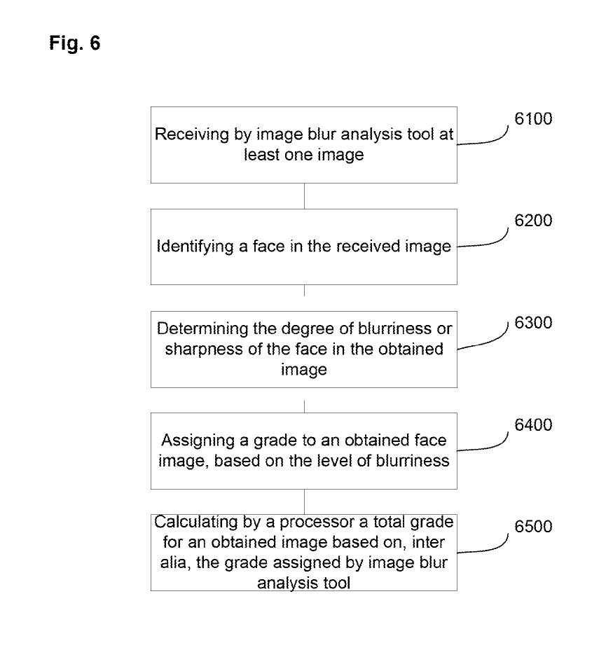

Reference is now made to FIG. 6 which is a flowchart of a method for identifying and grading image blur according to one embodiment of the present invention, for identifying deception attempts of an entrance control system. As may be seen in FIG. 6, image blur analysis tool may receive at least one image from image input device such as a video camera located at a monitored site, such as an entry to a secured area [block 6100]. Image blur analysis tool may identify a face in the received image [block 6200] and determine the degree of blurriness or sharpness of the face in the obtained image [block 6300]. Image blur analysis tool may then assign a grade to the image according to the degree of blurriness or sharpness of the image [block 6400]. It would be appreciated by those skilled in the art that when compressing an image, for example to a JPEG format, some information is lost and the sharpness of an image is reduced. It would be further appreciated that image blur analysis tool may detect attempts to present a pre-obtained image, such as a JPEG image, to the input device such as an imager, and bringing the pre-obtained image close to the imager in order to reach the minimal image size required for detection.

According to some embodiments of the present invention, when the detected blurriness of the face in a received image is high, a high grade may be assigned to the image, for example 10, and when the image is sharp a low grade may be assigned to the image, such as 1. Other grading methods and ranges may be used.

The grade assigned by image blur analysis tool may be received by the processing unit for use in determining a total grade for an obtained image [block 6500].

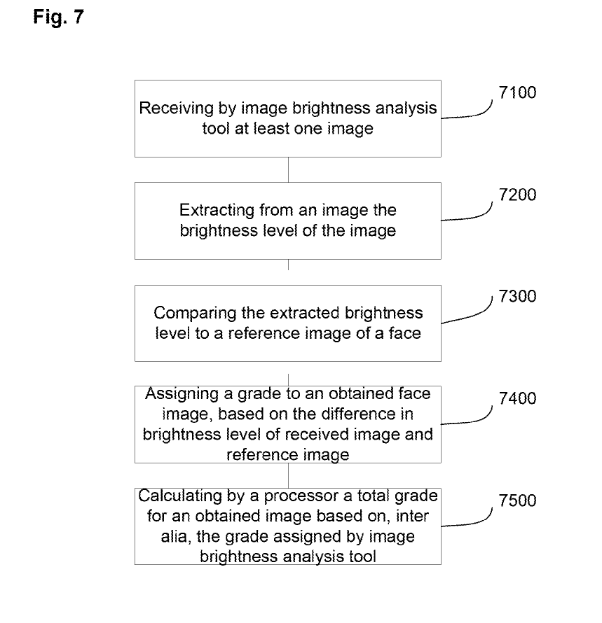

Reference is now made to FIG. 7 is a flowchart of a method for identifying and grading image brightness for identifying deception attempts of an entrance control system. As may be seen in FIG. 7, image brightness analysis tool may receive an image from input device, such as a camera located in a monitored site, such as an entrance to the secured area [block 7100]. Image brightness analysis tool may extract from a compressed image the brightness level of the image [block 7200]. The brightness level extracted from the received image is compared to a reference image of a face obtained in the same monitored site by the same input device in similar lighting conditions [block 7300] and a grade is assigned to the difference in brightness level of the received image from the brightness level of the reference image [block 7400]. When the brightness of the image received from the input device is higher than the expected brightness level in view of the brightness of the reference image, this may indicate that an image is presented to the input device on a display, such as an LCD screen or any other display known in the art. Thus, the grade associated with the received image may indicate high probability of deception.

The grade assigned by brightness analysis tool may be received by the processing unit for use in determining a total grade for an obtained image [block 7500].

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for identifying a fraud attempt of an entrance control system, the method comprising:
obtaining by an imaging system a plurality of images of an entrance point to secured area;
extracting image information from at least one of said plurality of images, to identify a person in said entrance point vicinity;
retrieve from a memory of said entrance control system stored data associated with said identified person;
apply a plurality of deception detection tools on said image information and assign a unique fraud grade by each deception detection tool;
calculate a combined fraud grade; and
compare said combined fraud grade to a threshold value to determine likelihood of fraud.

2. The method according to claim 1 further comprising allowing entrance to said secured area when said combined fraud grade is below said threshold value.

3. The method according to claim 1 wherein said plurality of deception detection tools are two or more from a group consisting of: edge recognition tool, background coverage tool, brightness identification tool, blur determination tool, arm location identification tool, 3D gaze determination tool, red eye determination tool, and normal behavior determination tool.

4. The method according to claim 3 further comprising:
receiving at least one voice sample through a voice input device; and
extracting voice information from at least one of said at least one voice samples, to identify a person in said entrance point vicinity; and
wherein said group of deception detection tools further consists of tools for extracting vocal biometric information.

5. The method according to claim 3 wherein each of said plurality of deception detection tools assigns a grade indicative of the probability of deception.

6. The method according to claim 5 further comprising assigning a weight to each grade and calculating a combined grade based on the weighted grades given by each deception detection tool.

7. The method according to claim 6 wherein the weight for each grade is determined according to the accuracy and reliability of each of said plurality of deception detection tools.

8. The method according to claim 7 wherein said weight is determined according to the conditions in the location of an input device.

9. The method according to claim 8 wherein said conditions are ambient light conditions and ambient noise conditions.

10. The method according to claim 1 further comprising applying at least one additional deception detection tool when said combined grade is above said threshold value.

11. A system for detecting deception attempts of an entrance control system, said deception detection system comprising:
an image input device;
a processor associated with said image input device; and
a memory, said memory to store a plurality of image analysis tools, biometric information and authorization information of at least one person;
wherein said processor is adapted to receive at least two images from said image input device and apply at least two of said plurality of image analysis tools to determine deception probability.

12. The system according to claim 11 further comprising an audio input device and wherein said memory further stores voice analysis tools to obtain vocal biometric information from input received from said audio input device.

13. The system according to claim 11 further comprising an illumination source.

14. The system according to claim 13 wherein said illumination source is an Infrared illumination source.

15. The system according to claim 11 wherein said processor is in active communication with a lock, said lock to change its position from locked position to unlocked position upon receipt of a signal from said processor.

16. The system according to claim 15 wherein said processor is adapted to issue said signal when said probability of deception is below a predefined threshold.

17. The system according to claim 16 wherein said probability of deception is determined by said processor according to a combined fraud grade calculated by said processor based on at least two fraud grades, each of said at least two fraud grades is assigned by one of said analysis tools.
